(19) United States
(12) Patent Application Publication
(10) Pub. No.: US 2026/0142093 A1
(43) Pub. Date: May 21, 2026

(54) TANTALUM CAPACITOR

(71) Applicant: SAMSUNG ELECTRO-MECHANICS CO., LTD., Suwon-si (KR)

(72) Inventors: Yujin Ham, Suwon-si (KR); Boumseock Kim, Suwon-si (KR); Myung Jin Jung, Suwon-si (KR); Sae Jin Sung, Suwon-si (KR); Sungyong An, Suwon-si (KR); Jae Yeong Kim, Suwon-si (KR)

(73) Assignee: SAMSUNG ELECTRO-MECHANICS CO., LTD., Suwon-si (KR)

(21) Appl. No.: 19/211,961

(22) Filed: May 19, 2025

(30) Foreign Application Priority Data
Nov. 15, 2024 (KR) 10-2024-0163076

(51) Int. Cl. H01G 9/042; H01G 9/048; H01G 9/07

(52) U.S. Cl. CPC H01G 9/0425; H01G 9/048; H01G 9/07

(57) ABSTRACT

A tantalum capacitor according to an embodiment of the present disclosure includes: a tantalum body; a tantalum wire that is connected to the tantalum body; a conductive polymer layer that is disposed on the tantalum body; and a first reinforcing layer that is disposed on the conductive polymer layer and includes carbon nanotube doped with iron (Fe).

### CROSS-REFERENCE TO RELATED APPLICATION

This application claims priority to and the benefit of Korean Patent Application No. 10-2024-0163076 filed at the Korean Intellectual Property Office on Nov. 15, 2024, the entire contents of which are incorporated herein by reference.

### BACKGROUND

### (a) Technical Field

A disclosure of the present application relates to a tantalum capacitor.

### (b) Description of the Related Art

A tantalum capacitor is an electronic component used in various passive component-intensive products such as a TV, a mobile device, a laptop computer, a tablet PC, a digital camera, a medical device, and a vehicle electrical component.

A tantalum (Ta) material is a metal that is widely used throughout industries such as electrical, electronic, mechanical, chemical engineering, space, and military fields due to mechanical and physical characteristics such as a high melting point and excellent softness and corrosion resistance. The Ta material has been widely used as an anode material of a small capacitor due to a characteristic capable of forming a stable anode oxidation film, and annual usages thereof have rapidly increased in accordance with rapid developments of information technology (IT) industries such as electronic and information communications in recent years.

As electronic products have recently become more dense and thinner, an equivalent series resistance (ESR) of the tantalum capacitor needs to be further reduced.

### SUMMARY

According to one aspect of the present disclosure, a tantalum capacitor having reduced resistance and improved stability may be provided.

However, a problem to be solved by embodiments of the present disclosure is not limited to the above-described problem, and may be extended in various ways within the scope of a technical idea included in the embodiments.

A tantalum capacitor according to an embodiment of the present disclosure includes: a tantalum body; a tantalum wire that is connected to the tantalum body; a conductive polymer layer that is disposed on the tantalum body; and a first reinforcing layer that is disposed on the conductive polymer layer and includes carbon nanotube doped with iron (Fe).

A content of iron of a total weight of the carbon nanotube doped with iron may be 0.5 wt % to 1.0 wt %.

The tantalum capacitor may further include a second reinforcing layer that is disposed on the first reinforcing layer and includes a conductive metal.

The conductive metal of the second reinforcing layer may include silver (Ag).

The conductive polymer layer may include at least one selected from the group consisting of polypyrrole, polythiophene, polyacetylene, and polyaniline.

The conductive polymer layer may include polyethylenedioxythiophene.

The tantalum capacitor may further include a dielectric layer that is disposed between the tantalum body and the conductive polymer layer.

The dielectric layer may include tantalum oxide.

The tantalum capacitor may further include a carbon layer that is disposed on the first reinforcing layer.

The tantalum capacitor may further include a second reinforcing layer that is disposed on the carbon layer and includes a conductive metal.

The carbon layer may include at least one selected from the group consisting of carbon black and graphite.

The carbon layer may include carbon black and graphite.

A thickness of the first reinforcing layer may be less than a thickness of the carbon layer.

The tantalum capacitor may further include a capsule portion that surrounds the tantalum body and the tantalum wire.

The capsule portion may include an epoxy resin.

The tantalum capacitor may further include a first lead frame that is connected to the tantalum wire.

The tantalum capacitor may further include a second lead frame that is electrically connected to the first reinforcing layer.

The conductive polymer layer and the first reinforcing layer may be a cathode, and the tantalum wire may be an anode.

The carbon nanotube doped with iron may include at least one selected from the group consisting of a single-wall carbon nanotube and a multi-wall carbon nanotube.

According to an embodiment of the present disclosure, electrical conductivity and contact stability with a conductive polymer layer of a tantalum capacitor may be improved through a first reinforcing layer disposed on the conductive polymer layer and including carbon nanotube (CNT) doped with iron (Fe).

According to an embodiment of the present disclosure, an equivalent series resistance (ESR) of the tantalum capacitor may be reduced.

### BRIEF DESCRIPTION OF THE DRAWINGS

FIG. 1 is a perspective view conceptually showing a tantalum capacitor according to an embodiment.

FIG. 2 is a cross-sectional view of the tantalum capacitor according to an embodiment cut along a line I-I′ of FIG. 1.

FIG. 3 is a schematic view conceptually showing an atomic structure of carbon nanotube doped with iron according to an embodiment.

FIG. 4 is a scanning electron microscope (SEM) analysis image of a cross-section of the tantalum capacitor according to an embodiment cut along the line I-I′ of FIG. 1.

FIG. 5 is a cross-sectional view of the tantalum capacitor according to another embodiment cut along the line I-I′ of FIG. 1.

FIG. 6 is a cross-sectional view of the tantalum capacitor according to another embodiment cut along the line I-I′ of FIG. 1.

FIG. 7 is an enlarged view of a portion A of FIG. 6.

FIG. 8 is a partial plan photograph of a tantalum capacitor according to Example 1.

FIG. 9 is a partial plan photograph of a tantalum capacitor according to Comparative Example 1.

FIG. 10 is a SEM analysis image of a cross-section of a tantalum capacitor according to Example 2.

FIG. 11 is a partial plan photograph of the tantalum capacitor according to Example 2.

FIG. 12 is a partial plan photograph of a tantalum capacitor according to Comparative Example 3.

FIG. 13 is a graph showing an equivalent series resistance (ESR) of a tantalum capacitor according to Example and Comparative Examples.

### DETAILED DESCRIPTION

An embodiment of the present disclosure will be described more fully hereinafter with reference to the accompanying drawings so that those skilled in the art could easily implement the embodiment. In order to clearly describe the present disclosure, parts or portions that are irrelevant to the description are omitted, and identical or similar constituent elements throughout the specification are denoted by the same reference numerals. In the accompanying drawings, some elements are enlarged, omitted, or schematically shown, and a size of each element does not accurately reflect its real size.

The accompanying drawings are only for easy understanding of the embodiment disclosed in the present specification, and a technical idea disclosed in this specification is not limited by the accompanying drawings, and the present disclosure should be understood to include all changes, equivalents, and substitutes included in the spirit and technical range of the present disclosure.

Terms including an ordinal number such as first and second may be used to describe various elements, but the elements are not limited by the terms. The terms are used only for a purpose of distinguishing one element from another element.

It should be understood that when an element such as a layer, a film, a region, or a plate is referred to as being “on” or “above” another element, it may be directly on the other element, or an intervening element may also be present. In contrast, when an element is referred to as being “directly on” another element, there are no intervening elements present. Further, in the specification, the word “on” or “above” means disposed on or below a referenced part, and does not necessarily mean disposed on the upper side of the referenced part based on a gravitational direction.

Throughout the specification, a term such as “comprise” or “have” is intended to designate that a feature, number, step, operation, constituent element, part, or combination thereof described in the specification exists, and it should be understood as not precluding the possibility of the presence or addition of one or more other features, numbers, steps, actions, constituent elements, parts, or combinations thereof. Thus, unless explicitly stated to the contrary, the word “comprise” and variations such as “comprises” or “comprising” should be understood to imply the inclusion of stated elements but not the exclusion of any other elements.

Throughout the specification, the phrase “in a plan view” or “on a plane” may mean when an object portion is viewed from above, and the phrase “in a cross-sectional view” or “on a cross-section” may mean when a cross-section taken by vertically cutting an object portion is viewed from the side.

Throughout the specification, the word “connected” does not mean only when two or more elements are directly connected, but also when two or more elements are indirectly connected through another element, or when two or more elements are physically connected or electrically connected, and it may include a case in which substantially integral parts are connected to each other although they are referred to by different names according to positions or functions.

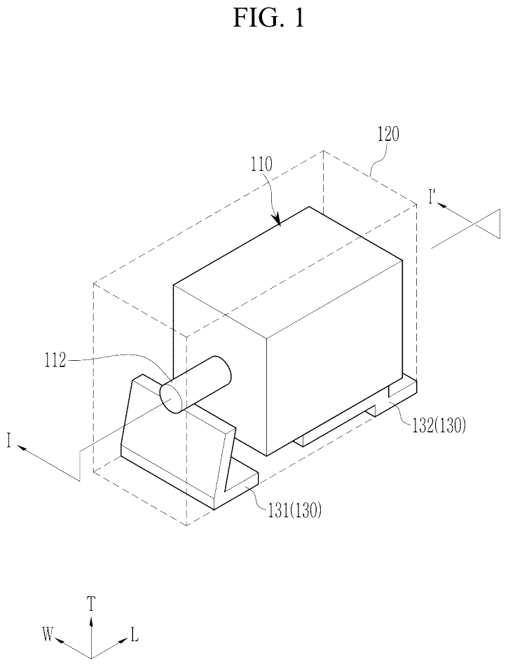

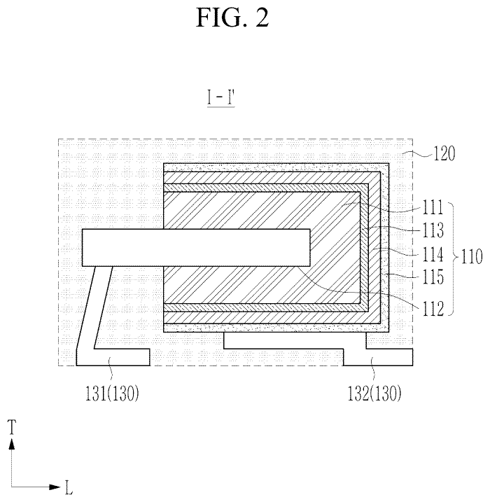

FIG. 1 is a transmission perspective view conceptually showing a tantalum capacitor according to an embodiment. FIG. 2 is a cross-sectional view of the tantalum capacitor according to an embodiment cut along a line I-I′ of FIG. 1.

An L-axis, a W-axis, and a T-axis shown in the drawings each represent a length direction, a width direction, and a thickness direction of each of the tantalum capacitor and a capacitor body 110.

The length direction (an L-axis direction) may be a direction that is approximately perpendicular to the thickness direction (a T-axis direction). For example, the length direction (the L-axis direction) may represent a direction in which a tantalum wire 112 extends. The width direction (a W-axis direction) may be a direction that is approximately perpendicular to the thickness direction (the T-axis direction) and the length direction (the L-axis direction). A length in the length direction (the L-axis direction) of the tantalum capacitor or the capacitor body 110 may be greater than a length in the width direction (the W-axis direction).

Referring to FIG. 1 and FIG. 2, the tantalum capacitor according to the embodiment may include the capacitor body 110.

The capacitor body 110 may include a tantalum body 111 and the tantalum wire 112 connected to the tantalum body 111.

A form of the tantalum body 111 may include a pellet, a sponge, a sheet, a foil, a mesh, or the like.

The tantalum body 111 may be formed using a tantalum (Ta) metal or a tantalum powder.

The tantalum powder may be manufactured by reacting a tantalum salt such as potassium fluorotantalate (K₂TaF₇), sodium fluorotantalate (Na₂TaF₇), or tantalum pentachloride (TaCl₅) with a reducing agent. These may be used alone or in combination of two or more.

The tantalum powder and a binder may be mixed at a predetermined ratio. The mixed powder may be compressed to be molded into a rectangular parallelepiped. The molded body may be sintered under high temperature and high vibration conditions to manufacture the tantalum body 111.

According to an embodiment, the tantalum wire 112 may be inserted into the tantalum body 111 to protrude from one side surface thereof.

When the tantalum body 111 described above is manufactured, a portion of the tantalum wire 112 may be inserted into a mixture of the tantalum powder and the binder in the length direction (the L-axis direction), and then may be formed and sintered together with the tantalum wire 112 and the tantalum body 111. For example, the tantalum wire 112 may be inserted to be disposed at a central portion in the thickness direction (the T-axis direction) of the tantalum body 111.

The tantalum wire 112 may be a tantalum metal rod having a rod shape, a bar shape, or the like. For example, the tantalum wire 112 may be provided as an anode of the tantalum capacitor.

According to an embodiment, a conductive polymer layer 113 may be disposed on a surface of the tantalum body 111. For example, the conductive polymer layer 113 may be provided as a cathode.

The tantalum body 111 may be immersed in a polymerization solution, and may be reacted in a polymerization furnace to form the conductive polymer layer 113.

The tantalum body 111 may include a porous structure. The conductive polymer layer 113 may be disposed on the tantalum body 111 to be provided as a filler for filling at least some of pores included in the porous structure.

The conductive polymer layer 113 may include polyethylenedioxythiophene (PEDOT), polypyrrole, polythiophene, polyacetylene, polyaniline, or the like. These may be used alone or in combination of two or more.

According to an embodiment, the capacitor body 110 may include a first reinforcing layer 114 disposed on the conductive polymer layer 113.

The first reinforcing layer 114 may include carbon nanotube (CNT) doped with iron (Fe). Accordingly, electrical conductivity and contact stability (e.g., contact stability between the first reinforcing layer and the conductive polymer layer) may be improved. Additionally, an interfacial resistance at a surface area of the tantalum body 111 may be reduced through the first reinforcing layer. Therefore, an equivalent series resistance (ESR) of the tantalum capacitor may be reduced.

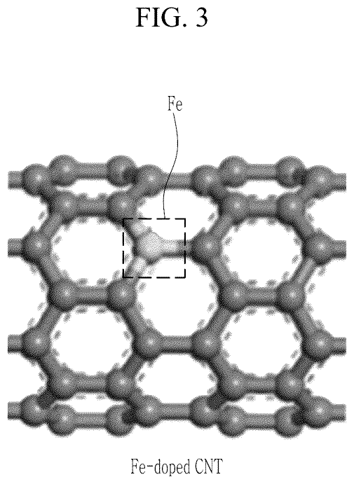

FIG. 3 is a schematic view conceptually showing an atomic structure of carbon nanotube (CNT) doped with iron according to an embodiment.

The CNT may have higher electrical conductivity than that of a general carbon material (e.g., carbon black or graphite).

Referring to FIG. 3, in the CNT doped with iron, a carbon atom on a surface of the CNT may be replaced with an iron atom, so that the electrical conductivity and an adhesive force of the CNT doped with iron are improved compared with those of CNT that is not doped with iron.

The CNT may include at least one selected from the group consisting of a single-wall CNT (SWCNT) and a multi-wall CNT (MWCNT).

For example, the first reinforcing layer 114 may be substantially formed of the CNT doped with iron.

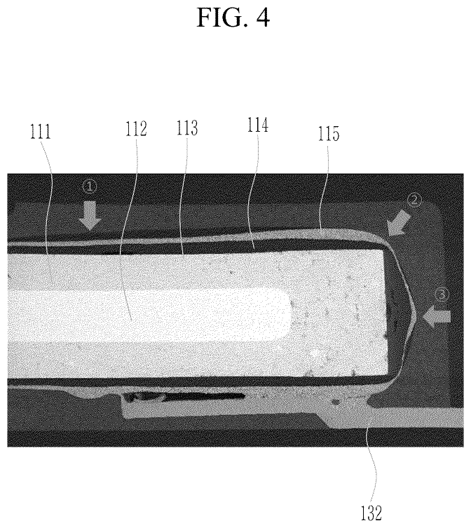

FIG. 4 is a scanning electron microscope (SEM) analysis image of a cross-section of the tantalum capacitor according to an embodiment cut along the line I-I′ of FIG. 1.

An existence and a component of the first reinforcing layer 114 may be measured by performing scanning electron microscopy-energy dispersive X-ray spectroscopy (SEM-EDS) on the tantalum capacitor.

The SEM-EDS analysis method may be used for a cross-section (e.g., an L-T cross-section) in which the tantalum capacitor is cut in the length direction (the L-axis direction) and the thickness direction (the T-axis direction) perpendicular to the width direction from a center of the width direction (the W-axis direction).

The tantalum capacitor may be polished using a polishing machine so that the cross-section is exposed. The polishing may be performed to delete a half of a length in the width direction (the W-axis direction). The polishing may be performed by sequentially increasing a grit of sandpaper to 200 grit, 800 grit, 1200 grit, 2000 grit, and 4000 grit at a low speed of 250 to 300 RPM. The grit may represent the number of particles per 1 cm² of sandpaper. After the polishing, flat milling may be performed with an ion milling equipment to prepare a sample with the exposed L-T cross-section. An existence and a component of each layer including the first reinforcing layer 114 may be obtained by performing EDS mapping analysis on a SEM analysis image of a cross-section of the sample. For example, in the SEM analysis image, an existence of the iron-doped CNT may be confirmed by analyzing a component of each of the first reinforcing layer 114 disposed on each of an upper surface (\textcircled{1} of FIG. 4), a side surface (\textcircled{3} of FIG. 4), and a corner portion where the upper surface and the side surface meet (\textcircled{2} of FIG. 4) of the capacitor body 110. The SEM analysis may be performed under conditions of a magnification of 1K to 20K, an acceleration voltage of 20 kV, and a working distance (WD) of 5 mm to 8 mm.

According to an embodiment, a content of iron of a total weight of the iron-doped CNT may be 0.5 wt % to 1.0 wt %. In the range, electrical conductivity and contact force of the first reinforcing layer 114 may be further improved, and structural stability may be further improved.

The content of iron may be measured through the SEM-EDS analysis described above. Other methods and/or tools appreciated by one of ordinary skill in the art, even if not described in the present disclosure, may also be used.

According to an embodiment, the capacitor body 110 may include a second reinforcing layer 115 disposed on the first reinforcing layer 114.

The second reinforcing layer 115 may include a conductive metal. For example, the second reinforcing layer 115 may include an epoxy resin including the conductive metal.

The conductive metal may include silver (Ag). Conductivity of the tantalum capacitor may be further improved using silver having high electrical conductivity. As an example, the second reinforcing layer 115 may include an epoxy resin including silver. For example, the second reinforcing layer 115 may be substantially formed of the epoxy resin including silver.

According to an embodiment, a thickness of the second reinforcing layer 115 may be 5 μm to 100 μm.

The first reinforcing layer 114 and the second reinforcing layer 115 may be provided as a cathode of the tantalum capacitor together with the conductive polymer layer 113.

According to an embodiment, the tantalum capacitor may further include a capsule portion 120 accommodating the capacitor body 110 described above.

The capsule portion 120 may surround the tantalum body 111 and the tantalum wire 112. Accordingly, the capacitor body 110 may be protected from external impact or contamination.

The capsule portion 120 may include an epoxy resin. For example, the capsule portion 120 may include a photocurable epoxy resin surrounding the capacitor body 110. For example, the epoxy resin may include an epoxy molding compound (EMC) or the like. For example, the capsule portion 120 may be formed using the epoxy resin by transfer molding, vacuum molding, compression molding, or the like.

According to an embodiment, the tantalum capacitor may further include a lead frame 130 electrically connecting the capacitor body 110 to the outside.

The lead frame 130 may include a conductive metal such as copper (Cu), nickel (Ni), or iron (Fe). These may be used alone or in combination of two or more.

The lead frame 130 may include a first lead frame 131 connected to the tantalum wire 112, and a second lead frame 132 connected to the first reinforcing layer 114 or the second reinforcing layer 115.

The tantalum wire 112 may be electrically connected to an external terminal through the first lead frame 131. For example, one end portion of the first lead frame 131 may be in contact with the tantalum wire 112, and the other end portion of the first lead frame 131 may be exposed to the outside of the capsule portion 120 to be electrically connected to the external terminal.

The first lead frame 131 may be provided as an anode lead frame.

The first reinforcing layer 114 or the second reinforcing layer 115 may be electrically connected to another electronic element through the second lead frame 132. For example, one end portion of the second lead frame 132 may be connected to the first reinforcing layer 114 or the second reinforcing layer 115, and the other end portion of the second lead frame 132 may be exposed to the outside of the capsule portion 120 to be electrically connected to an external terminal.

The second lead frame 132 may be provided as a cathode lead frame.

According to another example, a conductive adhesive layer (not shown) may be disposed between the one end portion of the second lead frame 132 and the first reinforcing layer 114 (or the second reinforcing layer 115). Accordingly, an adhesive force between the second lead frame 132 and the second reinforcing layer 115 may be further improved.

The conductive adhesive layer may be formed by applying and curing a conductive adhesive paste including an epoxy-based heat-curable resin and a conductive powder (e.g., silver (Ag)) on the second reinforcing layer 115.

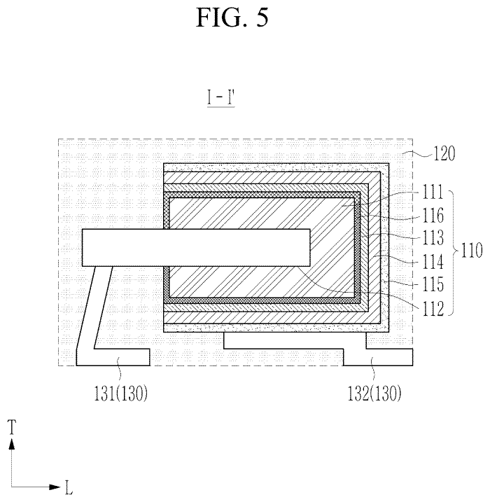

FIG. 5 is a cross-sectional view of the tantalum capacitor according to another embodiment cut along the line I-I′ of FIG. 1.

Referring to FIG. 5, in the other embodiment, a dielectric layer 116 may be disposed on the surface of the tantalum body 111. The dielectric layer 116 may be disposed between the tantalum body 111 and the conductive polymer layer 113.

The dielectric layer 116 may include a porous structure. For example, the dielectric layer 116 may form the porous structure together with the tantalum body 111. For example, after the dielectric layer 116 is formed on the tantalum body 111, the conductive polymer layer 113 may be formed. Accordingly, the conductive polymer layer 113 may be disposed on the dielectric layer 116 to be provided as a filler that fills at least some of pores included in the porous structure.

The tantalum body 111 may include a porous structure. The conductive polymer layer 113 may be disposed above the tantalum body 111 to be provided as a filler that fills at least some of pores included in the porous structure.

According to an embodiment, the dielectric layer 116 may include oxide of a tantalum metal. For example, the dielectric layer 116 may include tantalum pentoxide (Ta₂O₅).

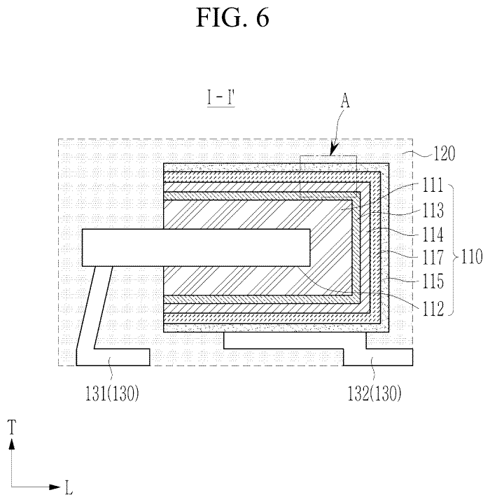

FIG. 6 is a cross-sectional view of the tantalum capacitor according to another embodiment cut along the line I-I′ of FIG. 1.

Referring to FIG. 6, in the other embodiment, the capacitor body 110 of the tantalum capacitor may further include a carbon layer 117 disposed on the first reinforcing layer 114.

If the second reinforcing layer 115 is disposed above the first reinforcing layer 114, the carbon layer 117 may be disposed between the first reinforcing layer 114 and the second reinforcing layer 115.

Because the carbon layer 117 and the first reinforcing layer 114 are used together, electrical conductivity and adhesion stability of the tantalum capacitor may be further improved.

The carbon layer 117 may include a carbon-based material such as carbon black or graphite. These may be used alone or in combination of two or more.

The carbon layer 117 may be provided as a cathode of the tantalum capacitor together with the conductive polymer layer 113, the first reinforcing layer 114, and/or the second reinforcing layer 115.

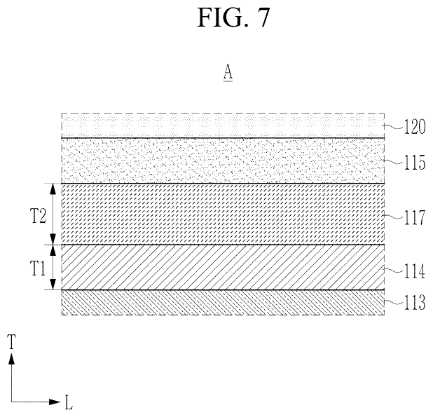

FIG. 7 is an enlarged cross-sectional view of a portion A of FIG. 6.

Referring to FIG. 7, in an embodiment, a thickness T1 of the first reinforcing layer 114 may be smaller than a thickness T2 of the carbon layer 117. In this case, an ESR of the tantalum capacitor may be reduced while structural stability of the capacitor body 110 is further improved.

The thicknesses T1 and T2 of each layer may indicate a length in a direction perpendicular to an extension direction of each layer on a cross-section.

The thickness T1 of the first reinforcing layer 114 and the thickness T2 of the carbon layer 117 may be measured using the SEM analysis method described above. Other methods and/or tools appreciated by one of ordinary skill in the art, even if not described in the present disclosure, may also be used.

According to an embodiment, a sum of the thickness T1 of the first reinforcing layer 114 and the thickness T2 of the carbon layer 117 may be 1 μm to 20 μm. The thickness T1 of the first reinforcing layer 114 may be 50% to 100% of the sum of the thickness T1 of the first reinforcing layer 114 and the thickness T2 of the carbon layer 117.

Hereinafter, a specific embodiment of the present disclosure is presented. However, an embodiment described below is only intended to specifically illustrate or describe the present disclosure.

### Experimental Example 1—Without Carbon Layer

### Example 1

The tantalum capacitor having the structure shown in FIG. 1 and FIG. 2 is manufactured.

Specifically, the tantalum body is manufactured by mixing a primarily granulated tantalum powder that is the tantalum powder, and camphor that is the binder, inserting the tantalum wire into the mixture, and forming and sintering the mixture with the tantalum wire inserted into a rectangular parallelepiped shape.

The tantalum body is immersed in the polymerization solution, and is reacted in the polymerization furnace to form the conductive polymer layer on a surface of the tantalum body. Polyethylenedioxythiophene (PEDOT) is used as the conductive polymer.

The first reinforcing layer is formed by dipping iron (Fe)-doped CNT on the conductive polymer layer. A content of iron of a total weight of the iron-doped CNT is 0.5 wt %.

The second reinforcing layer is formed by dipping silver (Ag) on the first reinforcing layer. Accordingly, the capacitor body including the tantalum body, the conductive polymer layer, the first reinforcing layer, and the second reinforcing layer is prepared.

The tantalum wire is connected to the first lead frame formed of copper (Cu), and the second reinforcing layer is connected to the second lead frame formed of copper (Cu).

The capsule portion is formed by molding the capacitor body, the first lead frame, and the second lead frame with an EMC to surround the capacitor body, the first lead frame, and the second lead frame. Accordingly, the tantalum capacitor including the capacitor body, the first lead frame, the second lead frame, and the capsule portion is manufactured.

### Comparative Example 1

A tantalum capacitor is manufactured using the same method as that of Example 1 except that the first reinforcing layer is formed using the same amount of CNT (i.e., CNT that is not doped with iron) as that of the CNT doped with iron.

### Evaluation—Coverage Evaluation

With respect to the tantalum capacitors according to Example 1 and Comparative Example 1 described above, the capsule portion is removed to expose the capacitor body.

A coverage of the first reinforcing layer is evaluated by observing an upper surface of the capacitor body with the naked eye.

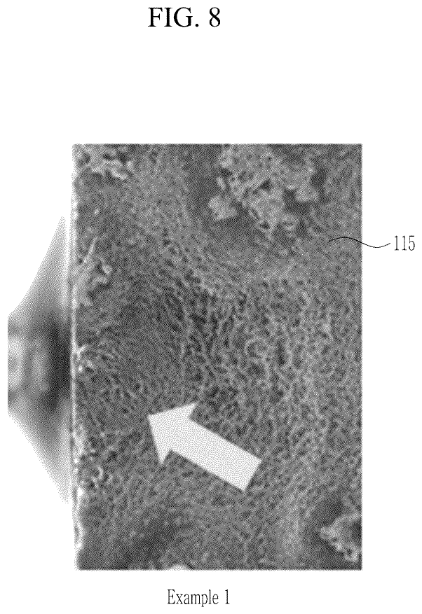

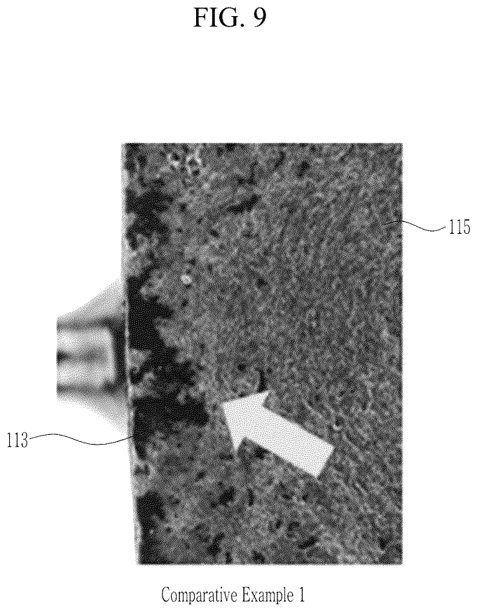

FIG. 8 is a partial plan photograph of the tantalum capacitor according to Example 1. FIG. 9 is a partial plan photograph of the tantalum capacitor according to Comparative Example 1. FIG. 8 and FIG. 9 are photographs of upper surfaces of the tantalum capacitors according to Example 1 and Comparative Example 1, respectively.

Referring to FIG. 8 and FIG. 9, adhesion/coverage with the conductive polymer layer of Example 1 including the first reinforcing layer including the iron-doped CNT is relatively increased compared with that of Comparative Example 1.

### Experimental Example 2—Including Carbon Layer

### Example 2

A tantalum capacitor is manufactured using the same method as that of Example 1 except that the carbon layer is formed by applying and drying a carbon paste (e.g., the carbon paste with a solid content of 20 wt %) in which carbon black and graphite are mixed at a weight ratio of 3:10 between the first reinforcing layer and the second reinforcing layer.

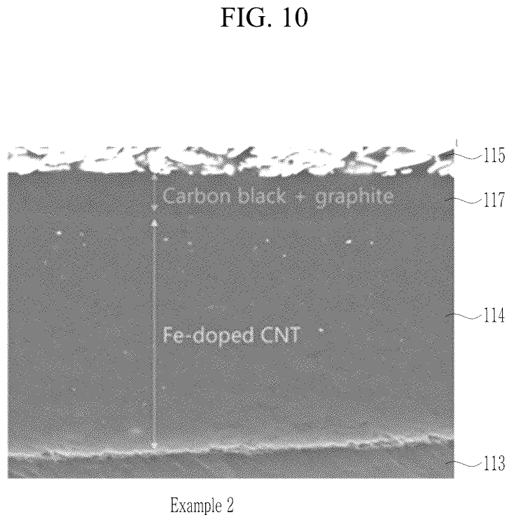

FIG. 10 is a SEM analysis image of a cross-section of the tantalum capacitor according to Example 2. FIG. 10 is the SEM analysis image of a cross-section (e.g., an L-T cross-section) in which the tantalum capacitor according to Example 2 is cut in the length direction (the L-axis direction) and the thickness direction (the T-axis direction) perpendicular to the width direction from a center of the width direction (the W-axis direction).

### Comparative Example 2

A tantalum capacitor is manufactured using the same method as that of Example 1 except that the first reinforcing layer is formed by applying and drying a carbon black paste (e.g., the carbon paste with a solid content of 10 wt %) on the conductive polymer layer instead of the iron-doped CNT and the carbon layer is formed between the first reinforcing layer and the second reinforcing layer like Example 2.

### Comparative Example 3

A tantalum capacitor is manufactured using the same method as that of Comparative Example 1 except that the carbon layer is formed between the first reinforcing layer and the second reinforcing layer like Example 2.

### Evaluation 1—Coverage Evaluation

With respect to the tantalum capacitors according to Example 2 and Comparative Example 3 described above, the capsule portion is removed to expose the capacitor body.

A coverage of the first reinforcing layer is evaluated by observing an upper surface of the capacitor body with the naked eye.

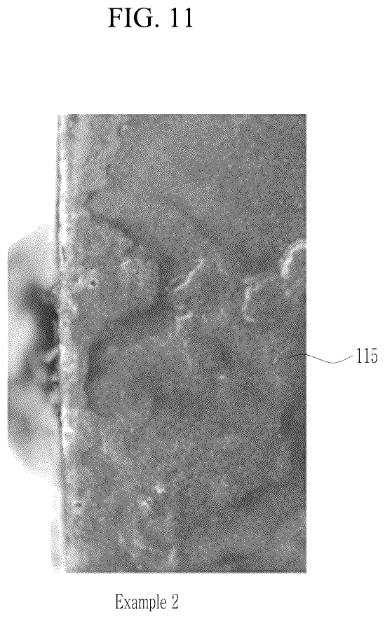

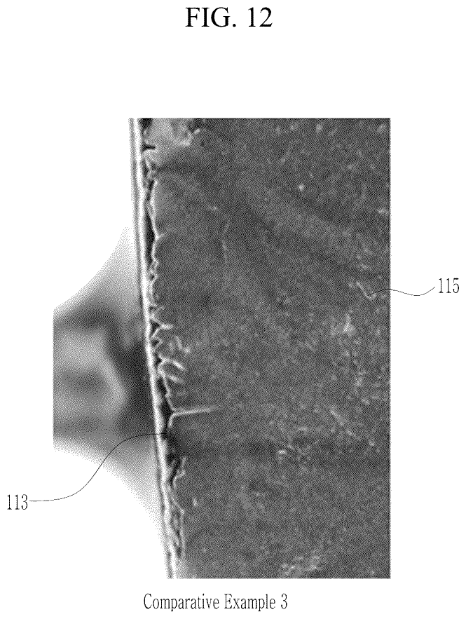

FIG. 11 is a partial plan photograph of the tantalum capacitor according to Example 2. FIG. 12 is a partial plan photograph of the tantalum capacitor according to Comparative Example 3. FIG. 11 and FIG. 12 are photographs of upper surfaces of the tantalum capacitors according to Example 2 and Comparative Example 3, respectively.

Referring to FIG. 11 and FIG. 12, adhesion/coverage with the conductive polymer layer of Example 2 including the first reinforcing layer including the iron-doped CNT is relatively increased compared with that of Comparative Example 3.

### Evaluation 2—Measurement of Equivalent Series Resistance (ESR)

A sample is prepared by welding 40 tantalum capacitors according to each of Example 2 and Comparative Examples 2 and 3 to an aluminum belt. The ESR of the sample is measured under conditions of 100 kHz and 1.5±0.5V using Keysight's E4980A model.

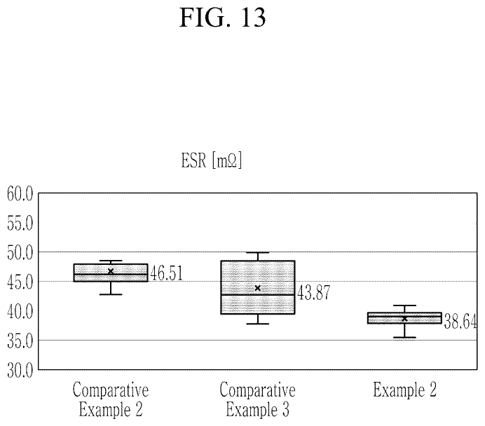

FIG. 13 is a graph showing an equivalent series resistance (ESR) of the tantalum capacitor according to Example 2 and Comparative Examples 2 and 3.

A component and an evaluation result of the first reinforcing layer are shown in Table 1 and FIG. 13 below.

TABLE 1

| | Component of first reinforcing layer | ESR (mΩ) |
|---|---|---|
| Example 2 | Iron-doped CNT | 38.64 |
| Comparative | Carbon black | 46.51 |
| Example 2 | | |
| Comparative | CNT that is not doped with iron | 43.87 |
| Example 3 | | |

Referring to Table 1 and FIGS. 11 to 13, adhesion/coverage with the conductive polymer layer of the embodiment including the first reinforcing layer including the iron-doped CNT is relatively increased compared with that of Comparative Example, and the ESR of the embodiment including the first reinforcing layer including the iron-doped CNT is relatively decreased compared with that of Comparative Example.

The ESR of the first reinforcing layer of Comparative Example 2 using the carbon black instead of the iron-doped CNT is relatively increased compared with that of Example 2.

The ESR of the first reinforcing layer of Comparative Example 3 using the CNT that is not doped with iron instead of the iron-doped CNT is relatively increased compared with that of Example 2.

What is claimed is:

1. A tantalum capacitor comprising:
a tantalum body;
a tantalum wire connected to the tantalum body;
a conductive polymer layer disposed on the tantalum body; and
a first reinforcing layer disposed on the conductive polymer layer and including carbon nanotube doped with iron (Fe).

2. The tantalum capacitor of claim 1, wherein a content of iron among a total weight of the carbon nanotube doped with iron is 0.5 wt % to 1.0 wt %.

3. The tantalum capacitor of claim 1, further comprising a second reinforcing layer disposed on the first reinforcing layer and including a conductive metal.

4. The tantalum capacitor of claim 3, wherein the conductive metal of the second reinforcing layer comprises silver (Ag).

5. The tantalum capacitor of claim 1, wherein the conductive polymer layer includes at least one selected from the group consisting of polypyrrole, polythiophene, polyacetylene, and polyaniline.

6. The tantalum capacitor of claim 1, wherein the conductive polymer layer includes polyethylenedioxythiophene.

7. The tantalum capacitor of claim 1, further comprising a dielectric layer disposed between the tantalum body and the conductive polymer layer.

8. The tantalum capacitor of claim 7, wherein the dielectric layer includes tantalum oxide.

9. The tantalum capacitor of claim 1, further comprising a carbon layer disposed on the first reinforcing layer.

10. The tantalum capacitor of claim 9, further comprising a second reinforcing layer disposed on the carbon layer and including a conductive metal.

11. The tantalum capacitor of claim 9, wherein the carbon layer includes at least one selected from the group consisting of carbon black and graphite.

12. The tantalum capacitor of claim 9, wherein the carbon layer includes carbon black and graphite.

13. The tantalum capacitor of claim 9, wherein a thickness of the first reinforcing layer is less than a thickness of the carbon layer.

14. The tantalum capacitor of claim 1, further comprising a capsule portion that surrounds the tantalum body and the tantalum wire.

15. The tantalum capacitor of claim 14, wherein the capsule portion includes an epoxy resin.

16. The tantalum capacitor of claim 1, further comprising a first lead frame connected to the tantalum wire.

17. The tantalum capacitor of claim 1, further comprising a second lead frame electrically connected to the first reinforcing layer.

18. The tantalum capacitor of claim 1, wherein the conductive polymer layer and the first reinforcing layer are a cathode, and the tantalum wire is an anode.

19. The tantalum capacitor of claim 1, wherein the carbon nanotube doped with iron includes at least one selected from the group consisting of a single-wall carbon nanotube and a multi-wall carbon nanotube.
